(19) United States
(12) Patent Application Publication
(10) Pub. No.: US 2026/0130373 A1
(43) Pub. Date: May 14, 2026

(54) EMULSIFIABLE CONCENTRATE (EC)

(71) Applicant: SYNGENTA CROP PROTECTION AG, Basel (CH)

(72) Inventors: Chih Min Wu, Singapore (SG); Yongjia Li, Singapore (SG)

(73) Assignee: SYNGENTA CROP PROTECTION AG, Basel (CH)

(21) Appl. No.: 19/121,496

(22) PCT Filed: Oct. 10, 2023
(86) PCT No.: PCT/EP2023/077956

§ 371 Date: Apr. 16, 2025

(30) Foreign Application Priority Data
Oct. 17, 2022 (SG) 1020225139IN

(51) Int. Cl. A01N 43/90; A01N 25/04; A01N 25/32; A01N 43/707; A01P 13/00

(52) U.S. Cl. CPC A01N 43/90; A01N 25/04; A01N 25/32; A01N 43/707; A01P 13/00

(57) ABSTRACT

A composition comprising pinoxaden, metribuzin and an adjuvant; wherein the adjuvant is a built-in oil-type adjuvant

The present invention relates to a liquid herbicidal composition comprising pinoxaden, metribuzin and a built-in oil-type adjuvant; together with uses and methods of preparing the same.

Pinoxaden (2,2-dimethyl-propionic acid 8-(2,6-diethyl-4-methylphenyl)-9-oxo-1,2,4,5-tetrahydro-9H-pyrazolo[1,2-d][1,4,5]oxadiazepin-7-yl ester) is a herbicide suitable for the control of grass weeds in certain cereals. Pinoxaden, due to the presence of the ester linkage, is extremely sensitive to pH, water, and salts and thus if the conditions are not appropriate it is converted into the corresponding acid.

Metribuzin (4-amino-6-tert-butyl-3-(methylthio)-1,2,4-triazin-5 (4H)-one) is a herbicide used both pre- and post-emergence in crops and acts by inhibiting photosynthesis by disrupting photosystem II.

Many grass herbicides (graminicides) for cereals require an adjuvant to develop full biological activity. In many cases the physico-chemical properties of the active ingredients make it difficult to add an adjuvant to the composition. Either because the chemical or physical stability of the active ingredient suffers from the added adjuvant or because biological performance is insufficient. It is in particular very challenging to make a biologically efficient and stable composition due to the chemical and physical instability of the herbicides used.

In general, formulated pinoxaden products are always applied in combination with adjuvants which may be built-in or added to the spray tank (so-called tank-mix adjuvants). The application of pinoxaden and tank-mix adjuvants is problematic in that physical incompatibilities often exist which may lead to poor biological efficacy and/or problematic application of the admixtures. These incompatibilities also lead to increased levels of flocculation which can result in the blocking of application equipment.

Adjuvants may also be incorporated into the herbicide composition (so-called built-in adjuvants). The use of a built-in adjuvant provides the advantage of ensuring the correct dosage of the adjuvant is used in practice. If too little adjuvant is used, the full efficacy potential of the formulation is not achieved. If too high a dose of adjuvant is administered, however, there is the possibility of damage to the crop.

Compositions of pinoxaden comprising a built-in adjuvant are challenging to formulate due to both the instability of pinoxaden and the difficulties achieving physical compatibility between the built-in adjuvant and the rest of the formulation. To this date, formulations have primarily relied upon tris(2-ethylhexyl) phosphate (TEHP).

In order to address these problems, the present invention therefore provides a composition comprising pinoxaden, metribuzin and an adjuvant; wherein the adjuvant is a built-in oil-type adjuvant.

It has surprisingly been found that the compositions according to the invention both address the formulation issues discussed above and demonstrate increased crop safety and technical performance. In particular, it has been found that the compositions according to the invention demonstrate better crop tolerance/safety on crops such as potatoes and wheat, while exhibiting higher efficacy, such as a greater level of grass control.

Preferably the built-in oil-type adjuvant is a polypropylene glycol ether, even more preferably a polypropylene glycol stearyl ether. Advantageously, the polypropylene glycol stearyl ether has the formula:

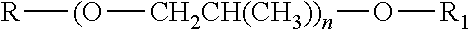

wherein R is a C12 to C18 straight- or branched-chain alkyl or alkenyl group, n is from 1 to 30, and R₁ is H or methyl. Preferably n is from 5 to 18 and/or wherein R is a C16 to C18 straight- or branched-chain alkyl.

Preferred polypropylene glycol stearyl ethers for use in the new compositions are stearyl ethers having between 10 and 20 polypropylene glycol units. Particularly preferred stearyl ethers include polypropylene-15-stearyl ethers and polypropylene-11-stearyl ethers. Polypropylene-15-stearyl ethers and polypropylene-11-stearyl ethers include Acconon® E (ABITEC), Arlamol™ PS15 (Croda Chem. Europe Ltd), Arlamol™ PS15E (Croda Inc), Finsolv® TPP (Innospec), Jeecol PSA-11 (Jeen International), Jeecol PSA-15 (Jeen International), Lipocol® P-15 (Lipo Chemicals), Lumisolve CSA-70 (Lambent Tech), Lumisolve CSA-75 (Lambent Tech), Procol™ PSA-11 (Protameen), Procol™ PSA-15 (Protameen), Sympatens ASP-150 (Kolb), Varonic® APS (Evonik), Witconol™ APS (Evonik), Finsolv® P (Innospec), and Prox-onic SA1-015/P (Protex International).

A particularly preferred polypropylene glycol stearyl ether is Arlamol™ PS15E, a stearyl ether having 11 polypropylene glycol units (Croda Chemicals Ltd. Goole, England).

Advantageously the built-in oil-type adjuvant is present in an amount of from 1 to 30% by weight, such as from 5 to 25% by weight, from 7 to 23% by weight, from 11 to 19% by weight, or even from 12 to 16% by weight.

Advantageously, the composition comprises no, or substantially no, tris(2-ethylhexyl) phosphate (TEHP). By ‘substantially no’ we mean less than 0.5% by weight.

Preferably the composition comprises pinoxaden in an amount from 0.05 to 50% by weight, from 0.1 to 30% by weight, from 0.5 to 20% by weight, from 0.8 to 15% by weight, from 1 to 9% by weight, or even from 3 to 7% by weight.

Preferably the composition comprises metribuzin in an amount from 1 to 65% by weight, from 2 to 55% by weight, from 4 to 45% by weight, from 5 to 35% by weight, from 8 to 30% by weight, from 9 to 25% by weight, from 11 to 20% by weight, or even from 15 to 19% by weight.

The composition may comprise a safener, preferably cloquintocet-mexyl or mefenpyr-diethyl, even more preferably cloquintocet-mexyl. Such a safener may be present in an amount of from 0.5 to 5% by weight, such as from 1 to 2% by weight.

Surfactants are included as emulsifiers, dispersants, and wetting agents. The surfactants useful in the new compositions are known in the art and comprise, for example, salts of alkyl sulfates, such as diethanolammonium lauryl sulfate; salts of arylsulfonates, such as calcium dodecyl-benzenesulfonate; alkylphenol-alkylene oxide addition products, such as nonylphenol ethoxylate; alcohol-alkylene oxide addition products, such as tridecyl alcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl) sulfosuccinate; sorbitol esters, such as ethoxylated sorbitol hexaoleate; quaternary amines, such as lauryl trimethylammonium chloride; polyethylene glycol esters of fatty acids, such as polyethylene glycol stearate; fatty alcohol alkoxylates which may be alkyl end-capped; block copolymers of ethylene oxide and propylene oxide; and salts of mono- and di-alkyl phosphate esters; alkylated polyvinylpyrrolidone, and also further substances described e.g. in “Mccutcheon's Emulsifiers & Detergents”, North American Edition, MC Publishing Co., 2018. It is also possible to use a mixture of one or more of these surfactants.

The total amount of surfactant may be comprised from 3 to 30% by weight, preferably from 4 to 25% by weight, such as from 5 to 20% by weight, or 6 to 19% by weight.

Particularly preferred are dodecyl-benzene sulfonic acid Ca-salts (which may be present in a range of from 1 to 10% by weight, such as 1.5 to 5%), the condensation product of castor oil and ethylene-oxide (which may be present in a range of from 1 to 15% by weight, such as 3 to 9% by weight), and/or oxirane polymer with methyloxirane block, derivatives (which may be present in a range of from 1 to 15% by weight, such as 3 to 9% by weight).

The new compositions may also comprise additional formulation aids known in the art such as crystallisation inhibitors, viscosity-modifying substances, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, micronutrients, plasticisers, glidants, lubricants, dispersants, thickeners, anti-freezes, microbiocides, and also liquid and solid fertilisers.

Each additional formulation ingredient may be present at a percentage (%) of weight/volume of from 0.01% to 5% by weight.

Preferably, the compositions according to the present invention are prepared in the form of an Emulsion Concentrate (EC).

However, it is also envisaged that the compositions according to the present invention may also be prepared in the form of a oil dispersion (OD), suspo-emulsion (SE) or suspension concentrate (SC). Such formulations are diluted prior to use. Diluted formulations can be prepared, for example, with water, liquid fertilisers, micronutrients, biological organisms, oil, or solvents.

Oil carriers can serve as a medium to disperse active ingredients. Oil carriers suitable for use in the composition of the present invention may be selected from rape seed oil, methylated rape seed oil, synthetic paraffins (e.g. (C12-C16), (C14-C18), (C15-C21), and (C18-C26)), dipropylene glycol dibenzoate, hydrocarbons (e.g. C11-C14, n-alkanes, isoalkanes, cyclics, and <2% aromatics), aromatic hydrocarbons (e.g. C10-C13, and <1% naphthalene), aromatic hydrocarbons (e.g. C9, and benzene <0.1%), mixtures of petroleum extracts comprising solvent-dewaxed light paraffinic and solvent-dewaxed heavy paraffinic distillates, solvent naphtha, citrate ester based solvents, tris (2-ethylhexyl) O-acetylcitrate, cyclohexanedicarboxylic acid, dinonyl ester, tri-n-hexyl-trimellitate, 1,2,4-benzenetricarboxylicacid, trihexylester, isopropyl myristate, decanedioic acid, bis(1-methylethyl) ester, isobornyl acetate (IBA, >94%), C8-C10 fatty acids methyl esters, triacetyl glycerine, and isoparaffinic hydrocarbon, or mixtures thereof.

A preferred solvent/carrier is benzoic acid methyl ester.

In a second aspect of the invention there is provided a method for inhibiting or controlling undesirable plant growth, such as grasses, wherein a herbicidally effective amount of the composition as described herein is applied to the plants or their habitat.

Crops of useful plants in which the compositions according to the invention can be used include especially cereals, in particular potatoes, wheat, durum wheat, triticale, rye and barley.

The term “crops” is to be understood as also including crops that have been rendered tolerant to herbicides or classes of herbicides (for example ALS, GS, EPSPS, PPO and HPPD inhibitors) as a result of conventional methods of breeding or genetic engineering. An example of a crop that has been rendered tolerant e.g., to imidoazolinones, such as imazamox, by conventional methods of breeding is Clearfield® summer rape (Canola). Examples of crops that have been rendered tolerant to herbicides by genetic engineering methods include e.g. glyphosate- and glufosinate-resistant maize varieties commercially available under the trade names RoundupReady® and LibertyLink®. The weeds to be controlled may be both monocotyledonous and dicotyledonous weeds, such as, for example, Stellaria, Apera, Avena, Setaria, Sinapis, Lolium, Echinochloa, Bromus, Alopecurus, Phalaris, Amaranthus, Chenopodium, Convolvulus, Chrysanthemum, Papaver, Cirsium, Polygonum, Matricaria, Galium, Viola and Veronica.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt-176 maize hybrids of NK® (Syngenta Seeds). The Bt toxin is a protein that is formed naturally by Bacillus thuringiensis soil bacteria. Examples of toxins and transgenic plants able to synthesise such toxins are described in EP-A-451 878, EP-A-374 753, WO 93/07278, WO 95/34656, WO 03/052073 and EP-A-427 529. Examples of transgenic plants that contain one or more genes which code for an insecticidal resistance and express one or more toxins are KnockOut® (maize), Yield Gard® (maize), NuCOTIN33BC (cotton), Bollgard® (cotton), NewLeaf® (potatoes), NatureGard® and Protexcta®. Plant crops and their seed material can be resistant to herbicides and at the same time also to insect feeding (“stacked” transgenic events). Seed can, for example, have the ability to express an insecticidally active Cry3 protein and at the same time be glyphosate-tolerant. The term “crops” is to be understood as also including crops obtained as a result of conventional methods of breeding or genetic engineering which contain so-called output traits (e.g. improved flavour, storage stability, nutritional content).

Areas under cultivation are to be understood as including land where the crop plants are already growing as well as land intended for the cultivation of those crop plants.

It is advantageous for the compositions according to the invention to be used as a ready to use mixture.

In a third aspect of the invention there is provided a method of preparing a composition as described herein.

Unless otherwise stated all percentages are given as percentages by total weight and all embodiments and preferred features may be combined in any combination.

The invention is described by the following non-limiting Examples.

### EXAMPLES

Composition A was prepared according to the invention, together with comparative composition B, with the components (% by weight) as set out in Table 1.

Further comparisons were carried out with commercially available products containing pinoxaden (composition D, Axial 50 EC®) and metribuzin (composition E, Adrino 70 WP®). A Tank Mix (composition C) containing Axial 50 EC® and Adrino 70 WP® (compositions D and E) in equivalent quantities to that of composition B was also prepared. The relevant components, where known, of these compositions are also set out in Table 1.

TABLE 1

| | | | | | Adrino |
|---|---|---|---|---|---|
| | | Comparative | Tank mix | Axial 50 EC | 70 WP |
| | A | B | C | D | E |
| Metribuzin | 17.5 | 17.5 | 17.5 | | 52.5 |
| Pinoxaden | 5 | 5 | 5 | 5 | |
| cloquintocet-mexyl | 1.25 | 1.25 | 1.25 | 1.25 | |
| Alkamuls EL 620 LI/E | 7.24 | 7 | | | |
| Nansa EVM 63/B | 3 | 3 | | | |
| Synperonic PE/L 64 | 7.24 | — | | | |
| TEHP | — | 34 | 34 | 34 | |
| Arlamol E | 14.2 | — | | | |
| Methyl Benzoate | Rest | Rest | | | |

TABLE 2

| | |
|---|---|
| Alkamuls EL 620 LI/E | condensation product of castor oil and ethylene-oxide |
| Nansa EVM 63/B | CaDDBS |
| Synperonic PE/L 64 | oxirane, polymer with methyloxirane, block, derivate |
| TEHP | Tris(2-ethylhexyl) Phosphate |
| Arlamol E | Polypropylene glycol stearyl ether |
| Methyl Benzoate | benzoic acid methyl ester |

### Physical and Chemical Properties

Composition A was tested for a range of properties as set out below.

pH

This method is based on CIPAC MT 75.3, where 1% dilution of the formulation in deionised water is measured.

### Persistent Foaming

This method is based on CIPAC MT 47.3. It specifies ambient temperature, Standard Hard Water ‘D’ and only records foam after 1 minute.

### Emulsion Stability

It is based on CIPAC MT 36.3 whereas emulsion stability is tested after 0.5 h and 2 h for standard hard water A and D.

100 ml of aqueous emulsion (0.4 percent v/v oil phase when diluted). The stability of this emulsion is then in terms of the amounts of free “oil” or “cream” which separates while the emulsion is allowed to stand undisturbed for 0.5 h and 2 h.

### Chemical Stability at Elevated Temperature

The formulation was tested according to their stability against chemical degradation at the temperatures and for the times set out below. The recovery (in percent) of the active ingredients Metribuzin, Pinoxaden, cloquintocet-mexyl were measured as an indication of the stability.

The results are set out in Table 3.

TABLE 3

| | | | | Emulsion | | | | |
|---|---|---|---|---|---|---|---|---|
| | Time & | | Persistent | Properties. | | recovery | recovery | recovery |
| | Temperature | pH | foaming | 0.5 h | 2 h | of MTB % | of PXD % | of CQC % |
| Comp. | initial | 4.81 | 20 | 0 | 0 | | | |
| A | 2 w @ 54° C. | 4.54 | 26 | 0 | 0 | 100.73 | 96.81 | 100.01 |
| | 4 w @ 50° C. | 4.47 | 12 | 0 | 0 | 100.09 | 95.33 | 99.85 |
| | 6 w @ 45° C. | 4.54 | 22 | 0 | 0 | 99.7 | 95.27 | 99.48 |
| | 8 w @ 40° C. | 4.58 | 18 | 0 | 0 | 100.47 | 97.06 | 100.54 |
| | 12 w @ 35° C. | 4.59 | 34 | 0 | 0 | 100.67 | 98.12 | 100.54 |
| | 12 w @ 40° C. | 4.48 | 32 | 0 | 0 | 100.61 | 95.54 | 100.31 |
| | 12 w @ RT | 4.69 | 32 | 0 | 0 | 99.92 | 99.15 | 100.17 |
| | 52 w @ RT | 4.69 | 38 | 0 | 0 | 100.18 | 95.4 | 100.83 |

Composition A can therefore be seen to exhibit a very high level of chemical stability together with suitable physical properties.

### Biological Performance

Composition A demonstrates better crop tolerance (i.e., reduced phytotoxicity) on potato and wheat than the equivalent TEHP-containing composition B at high rates of application.

(DAA=Days after Application.)

The results are set out in Tables 4 and 5.

TABLE 4

| | | Mean Phyto on | Mean Phyto on |
|---|---|---|---|
| Formulation | Rate gai/ha | Potato (7DAA) | Potato (14DAA) |
| Comp. A | 240 | 3.3 | 3.3 |
| | 160 | 1.7 | 1.7 |
| | 80 | 0 | 0 |
| Comp. B | 240 | 8.8 | 5.0 |
| | 160 | 1.7 | 1.7 |
| | 80 | 0 | 0 |

TABLE 5

| | | Mean Phyto on | Mean Phyto on |
|---|---|---|---|
| Formulation | Rate gai/ha | Wheat (7DAA) | Wheat (14DAA) |
| Comp. A | 240 | 7.2 | 5.2 |
| | 160 | 3.2 | 2.7 |
| | 80 | 0 | 0 |
| Comp. B | 240 | 9.2 | 7.2 |
| | 160 | 3.9 | 2.5 |
| | 80 | 0.8 | 0 |

Composition A also showed better crop safety on wheat compared against tank mix composition C at the same dose rate (50+175 gAl/ha). The results are set out in Table 6.

TABLE 6

| | Rate | Mean Phyto on | Mean Phyto on |
|---|---|---|---|
| Formulation | gai/ha | Wheat (7DAA) | Wheat (14DAA) |
| Comp. A | 225 | 5.8 | 3.6 |
| | 180 | 5.0 | 2.4 |
| Comp. C | 225 | 9.3 | 4.8 |

Composition A promoted better grass (Phalaris minor) control on potatoes compared against the tank mix of PXD+MTB (compositions C) at same dose rate (50+175 gAl/ha) or PXD solo (composition D) at 50 gAl/ha. The results are set out in Table 7.

TABLE 7

| | | Mean Grass | Mean Grass | Mean Grass |
|---|---|---|---|---|
| | | Control | Control | Control |
| Formulation | Rate gai/ha | (28DAA) | (42DAA) | (65DAA) |
| Comp. A | 270 | 91.7 | 93.3 | 91.7 |
| | 225 | 84.2 | 86.7 | 85.0 |
| | 180 | 82.5 | 85.0 | 83.3 |
| Comp. C | 225 | 70.0 | 70.0 | 66.7 |
| Comp. D | 50 | 51.7 | 50.0 | 48.3 |

Composition A also enables lower dose of MTB to be used for grass control in potatoes where the same effects are achieved versus the standard dose rate of MTB solo (composition E, 525 gAl/ha).

The test weed target Echinochloa colona was sprayed with compositions A and E. The results were obtained by visual assessments 28 days, 42 days, and 65 days after application with the mean average of the results being set out in Table 8 below.

TABLE 8

| | | Mean grass | Mean grass | Mean grass |
|---|---|---|---|---|
| | | Control | Control | Control |
| Formulation | Rate gai/ha | (28DAA) | (42DAA) | (65DAA) |
| Comp. A | 270 | 94.0 | 93.0 | 83.3 |
| | 225 | 92.0 | 91.3 | 80.0 |
| | 180 | 91.3 | 88.3 | 77.8 |
| Comp. E | 525 | 85.0 | 95.0 | 86.7 |

It can be seen that compositions according to the invention demonstrate an improvement in both crop safety and grass control when compared to existing compositions.

The invention is defined by the claims:

1. A composition comprising pinoxaden, metribuzin and an adjuvant; wherein the adjuvant is a built-in oil-type adjuvant.

2. The composition according to claim 1, wherein the built-in oil-type adjuvant is a polypropylene glycol ether.

3. The composition according to claim 2, wherein the polypropylene glycol ether is a polypropylene glycol stearyl ether.

4. The composition according to claim 2, wherein the polypropylene glycol stearyl ether has the formula: 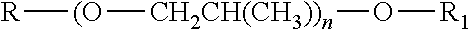
wherein R is a C₁₂ to C₁₈ straight- or branched-chain alkyl or alkenyl group, n is from 1 to 30, and R₁ is H or methyl.

5. The composition according to claim 4, wherein n is from 5 to 18 and/or wherein R is a C₁₆ to C₁₈ straight- or branched-chain alkyl.

6. A composition according to claim 1, wherein the built-in oil-type adjuvant is present in an amount of from 1 to 30% by weight.

7. A composition according to claim 1, wherein the pinoxaden is present in an amount of from 0.5 to 20% by weight.

8. A composition according to claim 1, wherein the metribuzin is present in an amount of from 5 to 35% by weight.

9. A composition according to claim 1, any of the preceding claims further comprising a safener, preferably cloquintocet-mexyl or mefenpyr-diethyl.

10. A composition according to claim 1, wherein the composition comprises substantially no tris(2-ethylhexyl) phosphate (TEHP).

11. A composition according to claim 1, which is in the form of an Emulsion Concentrate (EC).

12. A method for inhibiting or controlling undesirable plant growth, wherein a herbicidally effective amount of the composition according to claim 1 is applied to the plants or their habitat.

13. (canceled)

14. (canceled)

15. The method of claim 12, wherein the plant(s) is/are grass(es).
